(19) United States
(12) Patent Application Publication
(10) Pub. No.: US 2017/0243159 A1
(43) Pub. Date: Aug. 24, 2017

(54) Tracking Systems And Methods For Commodities

(71) Applicant: Co Vouch, LLC, Houston, TX (US)

(72) Inventors: James G Hurst, Houston, TX (US); Scott L Johnston, Houston, TX (US); Robert T Givens, Houston, TX (US); Joseph A Acayan, Houston, TX (US)

(73) Assignee: Co Vouch, LLC, Houston, TX (US)

(21) Appl. No.: 15/329,525

(22) PCT Filed: Mar. 5, 2015
(86) PCT No.: PCT/US15/18989

§ 371 Date: Jan. 26, 2017

Related U.S. Application Data
(60) Provisional application No. 61/948,318, filed on Mar. 5, 2014.

(51) Int. Cl. G06Q 10/08

(52) U.S. Cl. CPC G06Q 10/0833

(57) ABSTRACT

Methods and systems are disclosed that may include recording the commodity, whether in a container or not and optionally placing a readable label on such container, at a first location. The method may include storing recorded data having identifying parameters. Further still, the method may include moving the commodity to another location. Yet further, the method may include iterating, optionally, recording, optionally labeling, and storing additional recorded data having identifying parameters, wherein the recorded data having identifying parameters differs at each location as compared to any prior location where there is recorded data because a portion or the entirety of the recorded data that constitutes “stored data” may be accessed in order to generate and display a report that evidences the tracking of the commodity, regardless whether the tracking is for a process, shipment, transaction, or combination thereof for the commodity undergoing tracked movement.

### RELATED APPLICATION

This disclosure claims the benefit of pending U.S. Provisional Patent Application Ser. No. 61/943,318 filed on Mar. 5, 2014, the entirety of which is incorporated herein by this reference.

### FIELD OF DISCLOSURE

This disclosure generally relates to a method and technology for tracking a commodity during or subsequent to transit, whereby the tracking may provide a record, or a portion thereof, based on photographs, measurements, audio or video recordings, time sequences, and other identifying parameters, collectively referenced as any kind of data, that may be acquired and stored, for instance, in real-time or near real-time, and accessed or obtained by a requester or receiver, such as an importing or exporting agency, e.g., a country's customs department, in order to generate and display a report based on the stored data for possibly determining whether to allow the commodity into or out of the country, monitor a portion or entirety of a process or transaction, by providing robust and relevant evidentiary data respecting “who,” “what,” “where,” “when,” “how,” “why,” combinations thereof, and so forth.

### BACKGROUND

The civil and criminal laws of the United States and other countries governing the international trade of goods require that the correct origin, routing, and/or destination be declared and may also provide differing treatment for imported and exported goods based upon same. These differences in treatment may take many forms, e.g., quotas, lower duty rates, antidumping and countervailing duties, export control restrictions, endangered species controls, economic sanctions, health and safety controls, agricultural quarantines, human rights, child labor, etc., and even outright exclusion. Oftentimes, the treatment of commodities originating from or destined for different countries is so dramatic that traders may be willing to engage in fraudulent practices to misrepresent origin, routing, or destination in an attempt to mislead government officials (e.g., transshipping prohibited Iranian origin carpets to the U.S. through Turkey and misrepresenting them as of Turkish origin.)

Typically, government officials accept importers' country of origin declarations without question, or, in the case of an audit, rely upon customary documentary records provided by importers to support country of origin claims. Oftentimes, however, suitable documentary evidence is either not available or, in some cases, simply unpersuasive because, for example, of rampant transshipment regarding a particular commodity (e.g., where incentive to generate false documents is high) or the goods are of a type that is intrinsically difficult to document or effectively report (e.g., voluminous handwritten piece work records prepared by assembly line workers, which are not routinely compiled into database records). In cases where satisfactory documentary evidence does not exist to support an importer's or exporter's claims, goods from:to a country may be denied certain eligibility for benefits or subject to certain undo restrictions because of the United States' or other importing government's inability to rule out fraud or noncompliance. Such a denial may result in making a line of trade prohibited or uneconomical.

### SUMMARY OF THE INVENTION

In one example embodiment, there is a method for tracking a commodity. The method may include recording the commodity at a first location to produce recorded data having identifying parameters, wherein the recorded data is digitized audio, video, or audiovisual recordings. For example, the recording may be performed by photographing, recording sound, and/or filming audio and visual aspects of the commodity at any location, such as a facility, loading onto a truck, or otherwise. Further, the method may include storing, subsequent to recording, the recorded data having identifying parameters that are associated with the recorded data. Further still, the method may include moving, subsequent at least to the recording and maybe labeling also, the commodity to another location. Yet further, the method may include iterating, optionally, new recorded data of the commodity, subsequent to further moving to one or more locations subsequent to the another location, wherein each of the one or more locations has different identifying parameters associated with the new recorded data of the commodity as compared to the first location, the another location, or a previous one of the one or more locations. Finally, the method may include venerating a report on the tracking of the commodity based on stored data obtained from the recording, the storing, the moving, the iterating, or combinations thereof.

In another example embodiment, there is a system for tracking a commodity. The system may include a device having an application associated with memory and a processor, wherein the device takes records the commodity at a first location to produce recorded data having identifying parameters, wherein the recorded data is digitized audio, video, or audiovisual recordings. Further, the system may include one or more storage devices in network communication with and for storing of the recoded data. Further still, the system may include one or more additional devices, at one or more locations subsequent to the first location, for additional recorded data to produce additional recorded data having identifying parameters that have different identifying parameters as compared to the recorded data or any other of the additional recorded data that is associated with a previous one of the one or more locations. Finally, the system may include a computing device in network communication with stored data obtained from the recorded data, the additional recorded data, any other recorded data, or combinations thereof, for generating a report on the tracking of the commodity.

In yet another example embodiment, there is a method for tracking a commodity, wherein the tracking may be of the commodity undergoing a process, transaction, shipment or any other event or series of events associated with the commodity. The method may include generating, by a computing device associated with memory and at least one processor, a report for a tracked commodity based on stored data in network connection with the computing device, wherein the stored data comprises recorded data having identifying parameters, wherein the identifying parameters for the recorded data differs when obtained at different locations during movement of the tracked commodity. Further, the method may include reporting, subsequent to and based on the generating, the report for the tracked commodity on a peripheral device in communication with results from the generating.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for the disclosure may admit to other equally effective embodiments.

FIG. 1 depicts example embodiments of the disclosed methods and systems.

FIG. 2 depicts an example embodiment of a device for use in the disclosed methods and systems, and processes involved therewith.

FIG. 3 depicts an example embodiment of collection barrels or containers (i.e., used interchangeably through this disclosure) having readable labels that electability engage in sealing the containers, wherein the collection barrels or containers may be used to collect and aggregate the commodity, and/or divide the commodity into one or more portions, any or all of the foregoing may occur one or multiple times at any or all locations, beginning from the origin, during transit, and/or final destination of the commodity, in accordance with the disclosed methods and systems.

FIG. 4 depicts an example embodiment of a readable label having a barcode, an endorsement and other readable indicia in accordance with the disclosed methods and systems.

### DESCRIPTION OF EXAMPLE EMBODIMENTS

The following is a description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the scope of the disclosed invention as defined by the appended claims. The detailed descriptions below are designed to make such embodiments obvious to a person of ordinary skill in the art.

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

Disclosed are methods and systems for tracking imported commodities from/to origin/destination to a domestic/foreign port of entry. Logic, associated with one or more apps/applications accessible for use on a mobile computing device, e.g., PDA, smart phone, tablet, slate, etc., take photographs of the commodities at predetermined intervals, and, when coupled with labels and audiovisual equipment, provide an improved and reliable chain of collection, processing, export, and/or import movement for a commodity from beginning to end of the import or export process, or any process, transaction, shipment or any other event or series of events associated with the commodity. As used herein, commodity includes any good, item, article or thing.

Logic associated with the mobile device enables any and all photographs to be taken, and stored locally and/or uploaded, in real-time, in near real-time, in one or more batches at predetermined intervals, or when possible due to network accessibility, or combinations thereof, to a local or remote server, cloud or web service for database storage. To supplement the chain of custody of importable commodities during transit, one or more readable labels, or just referred to simply as “labels,” are affixed at the same or different times during the import transit process. For example, an initial label is optionally endorsed by the original supplier of the commodity, initial collector of the commodity, or similarly authorized person. The initial label may be a tamper-resistant seal placed on the unit of commodity at the time of closing the unit (e.g., closing a barrel with a lid followed by overlaying a first part of the seal on the lid and a second part of the seal on the outer surface of the barrel). The same or different mobile computing device, which may have recordable unique identifiers, take a picture of the sealed unit's label, wherein further logic uploads photograph(s) of the initial label, along with identifying parameters, such as global positioning satellite (GPS) data, cellular tower proximity data, Wi-Fi proximity data, time, date, producer's name, collector's name, mobile computing device's unique identifier, etc. The uploaded photograph(s) having the label may or may not be the first in the series of photographs taken during the import tracking process for the importable commodities at issue. Further enabling logic may encrypt any or all of the uploaded data, regardless whether the uploaded data is to the same or different database. If to a different database, then still further logic may provide associative keys, e.g., relational database(s), to join the database records.

After initial collection and sealing of each unit of importable commodities, the import tracking process may include additional mobile computing devices to move the commodities to one or more collection and/or processing facilities. Each of these locations, such as facilities, may advance the condition of the commodity and/or aggregate the units of commodities into successively larger containers of commodities, wherein each aggregation requires the opening of the sealed unit of commodity, re-closing, and re-labeling in the above-described manner. That is, each of these additional mobile computer devices also have enabling logic found in one or more apps; applications to photograph, and optionally encrypt the captured audio, video, or photographs and associated unique identifier(s), before automatically or manually uploading the photographs with the aforementioned global positioning satellite (GPS) data, cellular tower proximity data, Wi-Fi proximity data, time, date, and optionally additional data so that records of the foregoing exist in the same database, or, if in different database(s), are associated in order to join the database records. In this manner, multiple, related records are stored in secure, remote database(s) inaccessible to manipulation from importers—during movement of the importable commodity, wherein the commodity's movement from point of origin to foreign entry may be reliably re-created, at least for purposes of the commodity's country of origin/destination, from these records having dates, times, pictures, GPS data, cellular tower proximity data, Wi-Fi proximity data, mobile phone identifier(s), labels, signatures of collectors and producers, audiovisual data, etc.

In further embodiments, one or more audiovisual recording devices, whether operating continuously or intermittently, may, conspicuously or inconspicuously, take or capture additional recordings, e.g., photographs, filmings, sound recordings, etc., at random or predetermined intervals. These one or more audiovisual recording devices may be placed, for example, in a collection facility/warehouse in order to take additional photographs to show/record the above-discussed, successive aggregation(s) of smaller units into larger units during the import tracking process. The one or more audiovisual recording devices may have logic to upload identifying parameters, such as global positioning satellite (GPS) data, time, unique identifiers of audiovisual recording devices, themselves, and so forth. As with the one or more apps/applications' enabling logic, whether reduced to software and/or hardware, to upload to the database, the one or more audiovisual recording devices may also encrypt any or all of its uploaded data, regardless whether its uploaded data is to the same or different database from the taken or captured audio, video, audiovisual recordings, e.g., photographs, before and during the above-described initial labeling description. The audiovisual devices, themselves, are preferably under the control of the administrator of the disclosed method and system, and not the importer to safeguard against fraudulent records.

Turning to another description, this disclosure describes a method and system for creating, collecting, distributing, storing, and organizing evidence of origin, routing, and/or destination information that supports an importer's country of origin, routing, or destination declarations for presentation to government officials charged with accepting or denying said declarations, e.g., United States Customs and Border Protection, U.S. Bureau of Industry and Security. The disclosed methods and system create robust and verifiable documentary evidence through, inter alia, collection and storage of audiovisual records and associated metadata, with respect to the country of origin/destination of commodities/goods bound for importation/exportation into/from the U.S. or other nation enforcing its importation/exportation laws, while simultaneously frustrating attempts create false evidence.

In one embodiment, the disclosed method and system may include a programmable mobile phone, e.g., a smartphone, that also possessing a camera, GPS, Wi-Fi, Bluetooth, and cellular data transmission capabilities. A custom application, containing logic reduced to hardware and/or software, is installed onto a smartphone, wherein such smartphone allows a user to take, at least temporarily store, and send photographs of supply chain data and origin evidence that is automatically meta-tagged with GPS information, cellular data, Wi-Fi data, as well as time and date information. The application, which may be downloaded from the Internet or otherwise, may have further logic enabling only certain functions to work within certain geographic locations, such as within a production facility. The photographs, meta-tags, and associated data may be encrypted and written to such smartphone's internal memory. Encryption discourages potential tampering with the meta-tag information and frustrates the creation of false evidence. The photographs and the meta-tags may be uploaded, in real-time, near real-time, or upon opportunity using either the smartphone's wireless data connection and/or a Wi-Fi data connection, which includes any satellite data connections, to one or more database(s) in communication with the smartphone. The network(s), whether wired and/or wireless, permit the uploading, downloading, pushing, pulling, or other transmission of any and all data, such as identifying parameter(s) as often denominated herein. The application may direct, whether varied or measured, the time and/or circumstance at which the user may take or capture audio, video, audiovisual recordings. In this manner, specific stages of a good's collection, production, processing, packing, or exportation, are aggregated so as to create a thorough and persuasive trail of evidence that later supports an importer's country of origin claim.

Additionally and alternatively to the photographic evidence collected by the smartphone camera, the collected goods may be labeled and sealed with a unique number and/or bar code that may be visible when photographed. After the photograph(s) are taken, the smartphone software application, which may be reduced to one or more apps on a Windows®, Apple®, or Android® smartphone or the like, reads the unique number and/or bar code on the label and uses this information to generate yet another meta-tag associated with the set of photographs.

A single article, batch, or container of goods may be recorded by audially and/or visually recorded, e.g., photographed, multiple times while undergoing several of the steps previously mentioned before reaching inspection by a government official in its country of destination. In the United States, this government official would normally be a United States Customs and Border Protection officer, or some other officer of another agency with an interest in the particular type of importation—e.g., BIS, USDA, FDA, EPA, etc. The barcode scan acts as a unique number or other designation identifying an individual article, batch, or container of goods, in order to allow easy correlation between the various photos taken of an individual article, batch, or container of goods. In other example embodiments, there is not label or barcode, and, instead, unique number(s) or other unique indicia is placed on or exists on the commodity, itself.

Any or all photographs documenting the tracking history of good under export are uploaded, whether as a batch or individually as audio, video, and/or photographs are taken, to and stored in a database accessible through a portal or website located on one or more private or public computer systems. Government officials responsible for ensuring the validity of an importer's country of origin, routing, or destination claims may be provided digital security through use of a login name and password that permits such officials to have direct access to the raw records (e.g., photographs, metadata, etc.) and/or reports based on same. The audiovisual recordings and still photographs and meta-tag data may then be associated with a specific imported individual articles, batches or containers of goods based upon a unique number/bar code present on the article at the time of importation. By accessing the photographs and meta-tag data, the government official may directly confirm the history of each article, batch, or container of goods.

In one embodiment, the identifying parameter(s) associated with an individual article, batch, or container of goods is overlaid onto a Google®, MapQuest® or another's map with indications of the chronological time and place where the photographs were taken using the GPS alongside the time and date information meta-tagged to the recorded data that is stored as stored data.

As an example, the disclosed method and system may be used to verify the origin of honey imported into the United States. In this example embodiment, raw honey collected in the field is placed initially into field barrels (i.e., also called collection barrels) usually ranging from 40-120 kg from multiple beekeepers in scattered rural areas. Evidence gathering may be conducted by either the beekeeper or by the collector, wherein the collector may collect one or more beekeepers' honey. Audio and video may be captured and/or photographs may be taken of the barrels while open so that raw, unprocessed honey is visible inside the barrels. Audio and video may be captured and/or photographs may then be taken with the barrels closed and each sealed with tamper-evident labels applied in a manner and hand endorsed to prevent the subsequent reopening of a barrel without also destroying its label or leaving other evidence of tampering. The label may be visible in the photographs so that the unique number on the label will be readable in the photographs.

The barcode on the label may be scanned by the smartphone and uploaded via wired or wireless connection for storage on one or more databases. Additional, and optionally similar audio, video, or audiovisual evidence to that described in the preceding paragraph, capture and supplementary data logging may subsequently occur upon 1) the arrival at a central collection point of the barrels collected from beekeepers, 2) opening of the barrels and destruction of the label when the honey is processed at the processing facility, 3) filling 290-kg or other sized export barrels of processed honey intended for exportation, and/or 4) loading export barrels of processed honey into a shipping container for exportation to the U.S. or elsewhere. A security camera system may be placed in the location, such as a production facility, which will provide 24/7 monitoring with respect to all activity inside the production facility in order to show that honey brought in from the field is processed consistently with the other records captured and/or created by the disclosed methods and systems. To that end, the security camera system may take one or more photographs during the tracking of the processing of the honey and upload those photographs, also GPS and time and data stamped, directly or indirectly to the one or more databases in network connection with the storage of the other tracking records. In various embodiments, the security camera system, including its cameras, may be under the control of the party vouching for goods' origin, the processing plant, or others. Furthermore, subsequent to collection and processing, in one embodiment, a new serialized label may be affixed to the export barrels so that opening of the barrels destroys the label. This new label relates the export barrels back to the raw honey supply and evidentiary records collected in prior barrels, which may or may not be the initial barrels depending on the amount of collection, transfer, and/or processing. The labels used herein serve at least three functions: they capture the identity of the person applying the endorsement; they allow for photographs taken at each step to be easily traced throughout the process; and, they allow an additional source of evidence against transshipment.

In alternate embodiments, collected honey is processed at a facility by combining one or more collection distinct and traced barrels into a batch, wherein, as previously discussed, uploading of photographs of the collection barrels comprising the batch and labeling each batch may occur. From each batch, there are several other distinct and traceable export barrels that are produced. Once again, photographs of the export barrels and labels therefor may occur so as to continue creating a seamless web of evidence that may be used to re-create the transit of each drop of imported honey or other good as it may be in other examples. When each export barrel arrives into the port of entry, customs officials or the like may scan the export barrel, and that export barrel will correlate with a one or more collection barrels that comprise a particular batch. Therefore, the foregoing helps to point out that export barrels may not be linked 1-to-1 with collection barrels. Accordingly, a batch of export barrels may be linked with a batch of collection barrels. Additionally and alternatively to the use of photographs during the foregoing processing, the exact correlation of export barrels to collection barrels may be confirmed, for example, by a similarity in weight, which is logged and uploaded metadata collected and stored during the processing phase.

In another embodiment logging of honey collection is performed by a mobile device owned or associated with a specific beekeeper. That is, the beekeeper uses his own smartphone rather than have a phone issued to him for use with the disclosed methods and systems herein.

Further enabling logic, whether reduced to a separate app or merely associated with the custom app, permits sending and receiving payment. Here, the payment logic enables, for example, a buyer to make payment for a specific shipment, and/or a beekeeper to receive payment for the specific shipment using smartphones or other computer-based system having this payment functionality. When part of or associated with the custom app, then payment information records may be collected and uploaded to the database(s) that may already house photographs and other meta-tagged data for ultimately displaying on a monitor in network communication with the database(s).

In yet another embodiment, the custom application may have enabling logic to generate the commercial documents evidencing some or all of the transactions (e.g., invoices, delivery receipts, warehouse receiving reports, receipts, proof of payment, etc.) among any and all parties involved during the tracked transit of the exported goods. To that end, smartphones and/or computer systems may be in network communication with databases, as well as have access to word processing, spreadsheet, and presentation functionalities, for display, print, or other audiovisual showing that vouches for an exported good's country of origin through use of peripheral devices associated with such smartphones and/or computer systems. A peripheral device may be any auxiliary device, such as a computer mouse or keyboard, which connects to and works with the computer in some way. Other non-limiting examples of peripherals are expansion cards, graphics cards, image scanners, tape drives, microphones, speakers, webcams, printers, display screens, and digital cameras.

In keeping with the disclosed methods and systems, and, with respect to example embodiments of the same with regard to honey being the commodity at issue, below are tables and figures included with this disclosure. These tables and figures provide an overview of exemplary methods and systems as well as an example embodiment of the architecture. Furthermore, the tables and figures provide examples of when, where and of what photographs or other data may be collected, which may be meta-tagged, for instance, with GPS coordinates, cellular tower proximity data, Wi-Fi proximity data, time, date, and other identifying parameters.

Table 1 presents a high-level overview of the disclosed methods and systems in a presentation format that may be used in the tracking of a commodity such as honey from bee farm(s).

TABLE 1
Overview

Disclosed is a supply chain verification, tracking, and reporting solution
designed to generate robust, reliable, auditable, supply chain verification
and reporting . . . from the bee farm to the sealed shipping container.
Features include a custom smart phone data collection app,
24/7 video monitoring in a location, e.g., the processing
facility, and provides one or more reports, such as those tailored
for a governmental custom's department.
Generate robust, reliable, serialized, and auditable country-of-origin,
routing, and/or destination (“CO”) evidence.
Capture CO evidence using smart mobile devices. Examples of evidence
of such identifying parameters include product and worker images
time/date stamped and tagged with GPS coordinates, and associated with
serial number (“S/N”) barcode scans at key points throughout the
supply chain, coupled with 24/7 camera monitoring at the processing
and exporting facility.
Data may not be editable by user to ensure integrity of the
identifying parameters
Design and supply user-friendly report options.

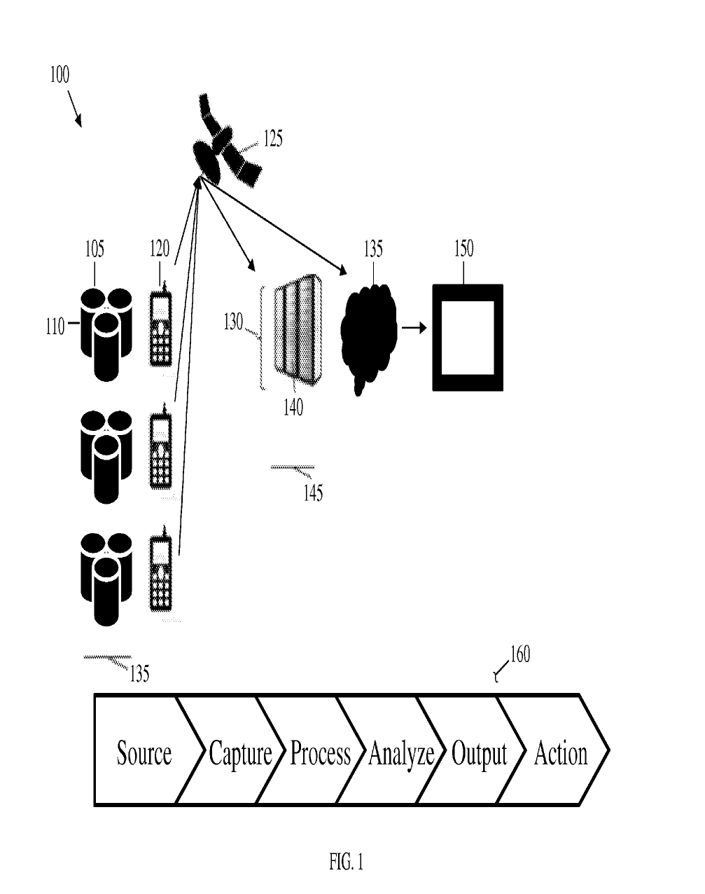

FIG. 1 presents an overview 100 of an example embodiment of the disclosed methods and systems. Labeled containers 105 having commodities 110 therein 105 are shown alongside devices 120, such as smartphones or other enabled computing device, having the capacity to record as audio, visual and or audiovisual, e.g., photograph, the containers 105 having commodities 110. Those photographs and identifying parameters may be transferred via network communications 125 to storage 130, such as one or more data centers having cloud storage, one or more databases, etc., which are located remotely, locally, and/or both to the initial location 135 and/or a later location 135 during transit of the containers 105 having commodities 110. Once at another location 145, which may or may not be the final destination of the containers 105 having commodities 110, report processing 135 may obtain the stored data 140 comprising the transmitted photographs and identifying parameters in order to generate/display a report 150. The report 150 may be tailored to a receiver's desires, e.g., a custom's division of a government, and, optionally, include real-time visualization options for the application loaded on or in association with the device having optionally associated resources, e.g., databases, cloud-storage, word processing, spreadsheet, presentation functionalities, input/output periphery devices, etc. for generating and/or displaying the report 150 based on the stored data that was or may be obtained in real-time or near real-time. Along the bottom of FIG. 1, there is a progressing bar 160 that depicts an example embodiment of steps involved in the disclosed methods and systems. For example, progressing bar 160 shows the commodity begins its tracked transit at a source, data is captured, processed, and analyzed in order to produce output for a report upon which the receiver of such report may take action, e.g., allow or disallow access of the commodity into or out of a country.

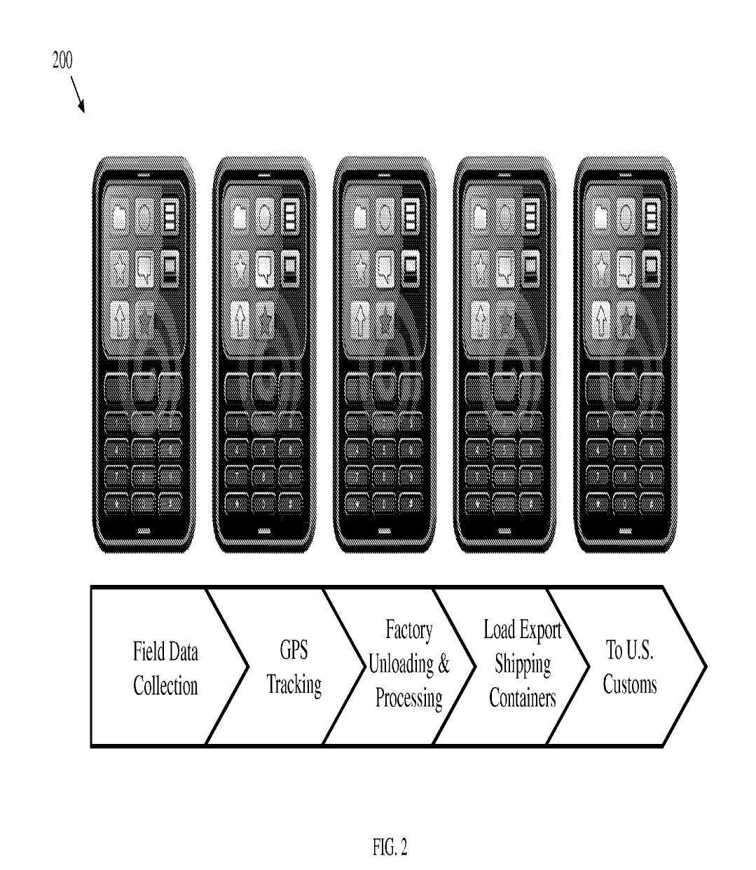

FIG. 2 depicts another example an overview 200 of the disclosed methods and systems. Here, devices, regardless whether they are the same or different, are used at different times during the course of transit of transit of the commodity in the container. Hence, in this overview 200, five devices are used at different locations, wherein the device may be the same device, or, more likely, be one of two, three, four, or five or more different but coordinated devices, all of which have the capability to functionally record audio and/or visual data and/or impart the recording, e.g., photographing, and gathering of identifying parameters for storage and later generation of a report based on the stored data. In this instance, the overview 200 depicts a progressing bar showing the device engaged in field data collection of photograph(s) and identifying parameters, GPS monitoring and tracking of the commodity in the container may occurs, and then factory (i.e., locational) unloading and processing of the commodity in the container may occur. The unloading and processing of the commodity in the container may occur at one location or may occur at multiple locations during transmit before ultimately arriving at a final location. During the unloading and processing, the commodity may be removed from the original container, and undergo one or multiple combinations, reductions, or combinations thereof with other commodities, but, all the while, identifying parameters are captured and placed into stored data so that the tracking of the commodity is a seamless and traceable transit for which a clean record exists when it is time to generate reports based on the stored data for the tracking of the commodity at issue. Such report(s), for instance, may be generated by U.S. Customs after arriving from being loaded and shipped in containers as depicted in overview 200.

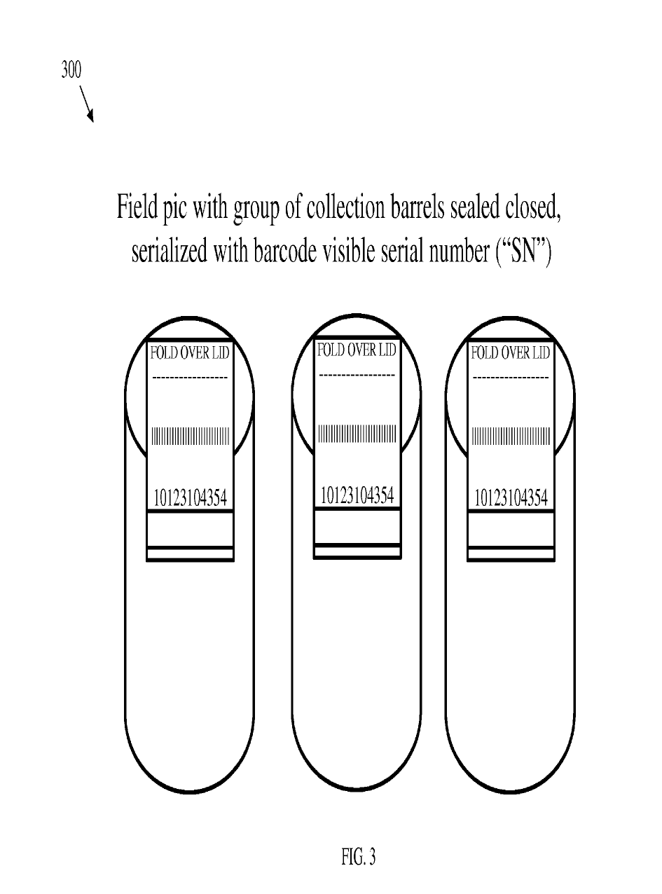

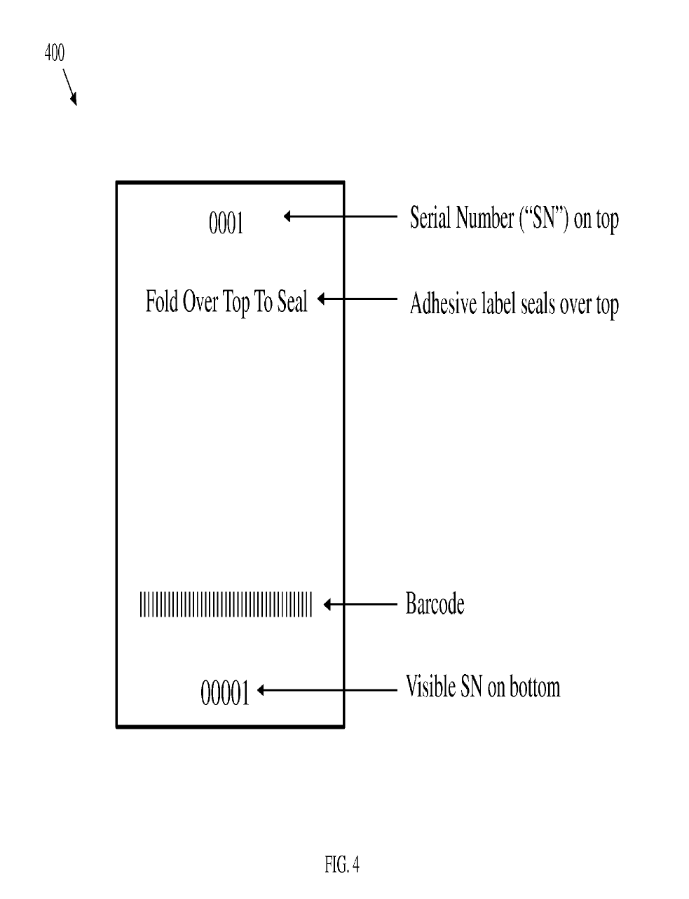

Moving on to FIG. 3, depicted is an example of a group 300 of collection barrels or containers (i.e., used interchangeably throughout this disclosure) having readable labels that electability engage in sealing the containers, wherein the collection barrels or containers may be used to collect and aggregate the commodity, and/or divide the commodity into one or more portions, any or all of the foregoing may occur one or multiple times at any or all locations, beginning from the origin, during transit, and final destination of the commodity, in accordance with the disclosed methods and systems. The readable labels, whether visually and/or via computer-aided devices and associated logic reduced to hardware and/or software in one or more application(s), have one portion that adheres to the top of the barrel and another portion that adheres to the side of the barrel, and, thereby, sealably engage the barrel. Moreover, the readable labels may be tear-resistant, contain one or more serial number(s) (“SN”) or other readable indicia. FIG. 4 shows a more up-close view of the readable label 400 that may engage in sealing and has readable indicia, including a visible endorsement, such as the farmer's initials for the commodity at issue, e.g., honey in the barrel.

Table 2 presents non-limiting examples of collectable data that may comprise identifying parameters in accordance with the disclosed or claims methods and systems.

TABLE 2

| | |
|---|---|
| Farmer/Product Images-Open Barrels | Surreptitious Back |
| Farmer/Product Images-Sealed Barrels | Pictures of Collector |
| (Visible SN) | Online-Registered |
| Collection Barrel SN | Collection Date & Time |
| GPS Position | Farmer ID |
| Camera Orientation | Collector ID |
| Position Accuracy | Device ID |
| Number of Barrels | |
| Barrel Weight | |

Other non-limiting examples include: elevation; temperature, pressure, volume, humidity, and/or other chemical or physical condition of the commodity, environment in which the commodity existed for any time before, during, or after transit of the commodity; route tracking; highway, road, street extrapolation(s); weather conditions, cellular tower proximity data, Wi-Fi proximity data, field/location imagery, audio captures, video captures, farmer label endorsement, transportation method, vehicle ID, farm images, images of transaction records, and so forth.

Table 3 presents examples of non-limiting collectable data at a location, such as a processing facility, that may comprise identifying parameters in accordance with the disclosed or claims methods and systems.

TABLE 3

| | |
|---|---|
| Received Barrel Images | Surreptitious Back |
| (Visible SN & farmer Initials) | Pictures of Receiver |
| Received Collection | Online-Registered |
| Barrel SN | Receipt Date & Time |
| Received Weight | Receiver ID |
| GPS Position | Device ID |
| Camera Orientation | |
| Position Accuracy | |

Other non-limiting examples include: elevation; temperature, pressure, volume, humidity, and/or other chemical or physical condition of the commodity, environment in which the commodity existed for any time before, during, or after transit of the commodity; route tracking; highway, road, street extrapolation(s); weather conditions, cellular tower proximity data, Wi-Fi proximity data, field/location imagery, audio captures, video captures, farmer label endorsement, transportation method, vehicle ID, farm images, images of transaction records, and so forth.

Table 4 presents examples of non-limiting collectable data at a location, such as a processing facility when the commodity at issue is honey that may comprise identifying parameters in accordance with the disclosed or claims methods and systems.

TABLE 4
Collection Barrel Scan at Unsealing and introduction to honey processing
Barrel Weight
Online-Registered Receipt Date & Time
GPS Position
Camera Orientation
Position Accuracy
24/7 Video Monitoring Record with Time/Date Stamp.
Device ID

Other non-limiting examples include: elevation; temperature, pressure, volume, humidity, and/or other chemical or physical condition of the commodity, environment in which the commodity existed for any time before, during, or after transit of the commodity; route tracking; highway, road, street extrapolation(s); weather conditions, cellular tower proximity data, Wi-Fi proximity data, field/location imagery, audio captures, video captures, farmer label endorsement, transportation method, vehicle ID, farm images, images of transaction records, and so forth.

Table 5 presents examples of non-limiting collectable data at a location, such as a an facility engaged in the export of drum(s) (i.e., barrel(s) or container(s)) of the commodity at issue, that may comprise identifying parameters in accordance with the disclosed or claims methods and systems.

TABLE 5

Export Drum SN
Export Drum Weight
Online-Registered Drum Pack Date & Time
GPS Position
Position Accuracy
24/7 Video Monitoring Record with Time/Date Stamp
Device ID
Packer ID

Other non-limiting examples include: elevation; temperature, pressure, volume, humidity, and/or other chemical or physical condition of the commodity, environment in which the commodity existed for any time before, during, or after transit of the commodity; route tracking; highway, road, street extrapolation(s); weather conditions, cellular tower proximity data, Wi-Fi proximity data, field/location imagery, audio captures, video captures, farmer label endorsement, transportation method, vehicle ID, farm images, images of transaction records, and so forth.

Table 6 presents a summary of an example embodiment of stored data that includes collected identifying parameters for the transportation of honey as the commodity at issue, wherein the collected identifying parameters comprises stored data that may undergo management and/or review, including possible use in the generation and display of a report based on the stored data in accordance with the disclosed or claims methods and systems.

TABLE 6

All images and data to be uploaded to online data storage
service in real-time or near real-time.
Data will be merged into records linking honey represented in
the collection records, processed through the facility, packed
into the export drums, and finally packed into the export
containers.
Data will be audited for indications of tampering, consistency,
red flags, etc.

Table 7 presents a summary of data reporting based on a requester or a receiver, such as Customs and Border Patrol (“CBP”), having access to or obtaining stored data to generate and display a report in accordance with the disclosed or claims methods and systems.

TABLE 7

Summary reports will be generated supported by full
underlying data, including images and time/date stamped
video.
CBP will be provided streamlined access to view data,
images, and reports.
Copies of data, images, and reports will be provided, as
appropriate.
Animated data reporting and other enhanced recording
options are under review.

An exemplary computer system, such as a smartphone or other computer-based device, for use with the disclosed methods and systems may include a processor, which is coupled to host bus coupled to cache memory. A host-to-personal computer interface (PCI) bridge is coupled to main memory, which includes cache memory and main memory control functions, and provides bus control to handle transfers among the PCI bus, processor, cache, main memory, and host bus. A PCI bus provides a standard interface for connecting peripherals, such as a local area network card A PCI-to-industry standard architecture (ISA) bridge functions as a PCI target on the PCI bus to manage transfers between PCI bus and ISA bus, universal serial bus functionality, integrated drive electronics device functionality, power management functionality, a real-time clock, direct memory access control, interrupt support, and system management bus support. Peripheral devices and input/output devices can be attached to various interfaces (e.g., parallel interface, serial interface, infrared interface, keyboard interface, mouse interface, fixed disk, removable storage device) coupled to ISA bus.

Basic input/output system is coupled to the ISA bus, and incorporates the necessary processor executable code for a variety of low-level system functions and system boot functions. BIOS can be stored in any computer readable medium, including magnetic storage media, optical storage media, flash memory, random access memory, read only memory, and communications media conveying signals encoding the instructions (e.g., signals from a network). In order to attach the computer system to another computer system to copy files over a network, a local area network card is coupled to PCI bus and to PCI-to-ISA bridge. Similarly, to connect the computer system to an ISP to connect to the Internet using a telephone line connection, a modem is connected to a serial port and the PCI-to-ISA Bridge.

While the foregoing computer systems are capable of executing the disclosure described herein, these computer systems are simply examples of computer systems and user computer systems. Those skilled in the art will appreciate that many other computer system designs are capable of performing the disclosure described herein.

Another embodiment of the disclosure is implemented as a program product for use within a device such as, for example, those above-described methods and systems. The program(s) of the program product defines functions of the embodiments (including the methods described herein) and can be contained on a variety of media including but not limited to: (i) information permanently stored on non-volatile storage-type accessible media (e.g., write and readable as well as read-only memory devices within a computer such as read-only memory, flash memory, CD-ROM disks readable by a CD-ROM drive); (ii) alterable information stored on writable storage-type accessible media (e.g., readable floppy disks within a diskette drive or hard-disk drive); and (iii) information conveyed to a computer through a network. The latter embodiment specifically includes information downloaded onto either permanent or even sheer momentary storage-type accessible media from the World Wide Web, an internet, and/or other networks, such as those known, discussed and/or explicitly referred to herein. Such data-bearing media, when carrying computer-readable instructions that direct the functions of the present disclosure, represent embodiments of the present disclosure.

In general, the routines executed to implement the embodiments of this disclosure, may be part of an operating system or a specific application, component, program, module, object, or sequence of instructions. The computer program of this disclosure typically comprises a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of this disclosure. However, it should be appreciated that any particular program nomenclature that follows is used merely for convenience, and thus this disclosure should not be limited to use solely in any specific application identified and/or implied by such nomenclature.

In one example embodiment, the computer system, and methods enabled by the same, comprise a server having a processor and a memory, wherein the server is in network communication with a database and at least one modifiable educational app, wherein the at least one modifiable educational app is proprietary to a publisher. A first set of logical instructions, associated with an integration application, are associated with the computer system for modifying the at least one modifiable educational app to yield a modified educational app. A second set of logical instructions, associated with the integration application, are for recording usage data of the modified educational app in the database. A third set of logical instructions, associated with the integration application, are for obtaining at least a portion of the usage data recorded in the database. A fourth set of logical instructions, associated with the integration application, are for analyzing the at least a portion of the usage data to yield a comparison. A fifth set of logical instructions, associated with the integration application, are for generating a configurable report of the comparison. The first set, second set, third set, fourth set, and fifth set of the logical instructions are stored on at least one or more storage devices for execution by one or more processors via one or more memories of the computer system.

While the foregoing is directed to example embodiments of the disclosed invention, other and further embodiments of the invention may be devised without departing from the basic scope thereof, and the scope thereof is determined by claim(s).

What is claimed is:

1. A method for tracking a commodity, the method comprising:
recording the commodity at a first location to produce recorded data having identifying parameters, wherein the recorded data is digitized audio, video, or audiovisual recordings;
storing, subsequent to the recording, the recorded data having identifying parameters;
moving, subsequent at least to the recording, the commodity to another location;
iterating, optionally, new recorded data of the commodity, subsequent to further moving to one or more locations subsequent to the another location, wherein each of the one or more locations has different identifying parameters associated with the new recorded data of the commodity as compared to the first location, the another location, or a previous one of the one or more locations; and
generating a report on the tracking of the commodity based on stored data obtained from the recording, the storing, the moving, the iterating, or combinations thereof.

2. The method of claim 1, further comprising removing one or more portions of the commodity from an aggregated collection of the commodity before commencing the method, during the moving of the commodity, during the further moving of the commodity, or combinations thereof.

3. The method of claim 1, further comprising encrypting the stored data.

4. The method of claim 1, further comprising transacting one or more payments for the commodity before and/or subsequent to commencing the method, and incorporating, optionally, one or more records for the transacting into the stored data.

5. The method of claim 1, further comprising generating commercial documents that evidence one or more transactions during transit of the commodity before and/or subsequent to commencing the method, and incorporating, optionally, any of the commercial documents into the stored data.

6. The method of claim 1, further comprising labeling the commodity at one or more locations during performance of the method, wherein the labeling comprises placing a label on the commodity or on a container having the commodity.

7. The method of claim 1, wherein the method comprises enabling logic associated with an application having configurable roles and permissions for permitting or restricting access to any of the recorded data, any of the stored data, functionalities, or combinations thereof, in order to perform at least a portion of the method on a device in communication with the enabling logic, associated resources, the stored data, or combinations thereof.

8. The method of claim 1, wherein the method comprises uploading, downloading, pulling, pushing or otherwise transmitting or receiving any portion of the stored data from one or more local locations, one or more remote locations, or combinations thereof.

9. The method of claim 1, wherein the recording comprises recording, at one or more random or predetermined intervals, that are at the first location, the another location, the one or more locations, at other locations or combinations thereof.

10. The method of claim 1, wherein the recording, the storing, or combinations thereof occur in real-time, near real-time, one or more batches at predetermined intervals, when possible due to network accessibility, or combinations thereof.

11. The method of claim 1, wherein the labeling further comprises sealing, and, optionally, through use of a label.

12. The method of claim 1, wherein the generating comprises overlaying a subset or an entirety of photographs in the stored data onto a map.

13. The method of claim 1, wherein the generating comprises generating the report based on the identifying parameters, the different identifying parameters, or combinations thereof in the stored data.

14. The method of claim 1, wherein the method comprises the tracking of a process for, a transaction of, or a shipment of the commodity or portion thereof.

15. A system for tracking a commodity, the system comprising:
a device having an application associated with memory and a processor, wherein the device takes records the commodity at a first location to produce recorded data having identifying parameters, wherein the recorded data is digitized audio, video, or audiovisual recordings;
one or more storage devices in network communication with and for storing of the recoded data;
one or more additional devices, at one or more locations subsequent to the first location, for additional recorded data to produce additional recorded data having identifying parameters that have different identifying parameters as compared to the recorded data or any other of the additional recorded data that is associated with a previous one of the one or more locations; and
a computing device in network communication with stored data obtained from the recorded data, the additional recorded data, any other recorded data, or combinations thereof, for generating a report on the tracking of the commodity.

16. The system of claim 15, further comprising a readable label placed on either the commodity or a container having the commodity, wherein the readable label optionally comprises a tamper-resistant label, a barcode, an endorsement, other readable indicia on the readable label, or combinations thereof.

17. The system of claim 15, wherein any of the identifying parameters comprises data about dates, times, photographs, pictures, mobile computing devices, global positioning coordinates, mobile phone identifiers, labels, measurements, signatures of collectors and producers, audio data, visual data, audiovisual data, photographs, equipment information, geographical indicators, recorded activity at one or more locations or during transit, payment transaction records, tracing information, collecting and batch information, records of and about commercial documents, elevation, temperature, pressure, volume, humidity, chemical properties, physical properties, environmental conditions, route-tracking, highways, roads, street extrapolation(s), or one or more numbers located on or associated with the commodity.

18. The system of claim 15, wherein the device comprises mobile or stationary computing devices, audio devices, visual devices, audiovisual devices, recording devices, camera devices, security camera system devices, or combinations thereof.

19. The system of claim 15, wherein the one or more storage devices comprise databases or cloud-based storage devices that are local, remote, or combinations thereof to the system, and the network communication is wired, wireless, or combinations thereof.

20. A method for tracking a commodity, the method comprising:
generating, by a computing device associated with memory and at least one processor, a report for a tracked commodity based on stored data in network connection with the computing device, wherein the stored data comprises recorded data having identifying parameters, wherein the recorded data is digitized audio, visual, or audiovisual recordings, wherein the identifying parameters for the recorded data differ when obtained at different locations during movement of the tracked commodity; and
reporting, subsequent to and based on the generating, the report for the tracked commodity on a peripheral device in communication with results from the generating.
